(19) United States
(12) Patent Application Publication
(10) Pub. No.: US 2007/0141288 A1
(43) Pub. Date: Jun. 21, 2007

(54) Double coated pressure sensitive adhesive tape

(75) Inventors: Yuki Hongo, Nakano-ku (JP); Kenta Tomioka, Saitama-shi (JP); Tomoo Orui, Saitama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: LINTEC CORPORATION, Tokyo (JP)

(21) Appl. No.: 11/600,565

(22) Filed: Nov. 16, 2006

(30) Foreign Application Priority Data
Dec. 19, 2005 (JP) 2005-364939

(51) Int. Cl. B32B 33/00

(52) U.S. Cl. 428/40.1

(57) ABSTRACT

A double coated pressure sensitive adhesive tape comprising pressure sensitive adhesive layers which comprise an acrylic ester-based copolymer having a weight-average molecular weight of 700,00 or greater and a content of a butyl acrylate unit of 90% by mass or greater and 40 to 60% by mass of a tackifier as main components and are disposed on both faces of a core material, wherein the thickness of the entire tape including the core material and the adhesive layers is 30 μm or smaller, and the thickness of the adhesive layer on each face is 2 to 10 μm. The tape is transparent and thin, is advantageously used for fixing members of portable terminals such as portable telephones and PDA and thin film displays, laminating substrates in optical disks and fixing polarizing plates and exhibits excellent adhesive strength and holding power at high temperatures.

### TECHNICAL FIELD

The present invention relates to a double coated pressure sensitive adhesive tape and, more particularly, to a double coated pressure sensitive adhesive tape which is transparent and thin, is advantageously used for fixing members of portable terminals such as portable telephones and PDA and thin film displays such as electroluminescence devices and electronic papers, laminating substrates in optical disks and fixing polarizing plates and exhibits excellent adhesive strength and holding power at high temperatures.

### BACKGROUND ART

Recently, in the field of electronic and optical products such as portable terminals (portable telephones, PDA and the like), digital cameras and digital video cameras, decreases in the thickness and the weight, which are further leading to development of paper-thin display devices, have been studied along with improvements in the functions.

In fixing members in these electronic and optical products, the decrease in the thickness is achieved by using a tape obtained by transcription of a pressure sensitive adhesive layer in some applications. This process has a drawback in that durability is poor due to the absence of a core material. Many double coated pressure sensitive adhesives having a decreased thickness have been developed to overcome the drawback. However, the decrease in the thickness of the pressure sensitive adhesive layer is limited since the product is required to pass the test under a severe environment.

As the double coated pressure sensitive adhesive tape having a small thickness and used for fixing electronic and optical members, for example, a double coated pressure sensitive adhesive tape or sheet having a pressure sensitive adhesive layer on both faces of a support, wherein the thickness of the entire tape including the support and the two pressure sensitive adhesive layers formed on both faces of the support is 3 μm or greater and smaller than 30 μm and the strength at break is 2 to 26 MPa/10 mm width, is disclosed (refer to Patent Reference 1).

The above double coated pressure sensitive adhesive tape or sheet has an object of obtaining an excellent strength at break even when the thickness is small. No descriptions are provided on the relation between the thickness of the pressure sensitive adhesive layer and the adhesive strength or on the molecular weight of the acrylic polymer used for the pressure sensitive adhesive layer which greatly affects the adhesive strength and the holding power at high temperatures. In an example, an acrylic polymer having a weight-average molecular weight of 500,000 is used. It was found by the present inventors that a sufficient holding power at high temperatures could not be obtained when an acrylic polymer having a low molecular weight such as that described above is used for the pressure sensitive adhesive layer.

Double coated pressure sensitive adhesive tapes are used for laminating substrates in optical disks and for fixing polarizing plates. A double coated pressure sensitive adhesive tape having a small thickness of the entire tape has been desired also in these applications.

[Patent Reference 1] Japanese Patent Application Laid-Open No. 2005-105212

### DISCLOSURE OF THE INVENTION

### [Problems to be Overcome by the Invention]

Under the above circumstances, the present invention has an object of providing a double coated pressure sensitive adhesive tape which is transparent and thin, is advantageously used for fixing members of portable terminals such as portable telephones and PDA and thin film displays, laminating substrates in optical disks and fixing polarizing plates and exhibits excellent adhesive strength and holding power at high temperatures.

### [Means for Overcoming the Problems]

As the result of intensive studies by the present inventors to develop the double coated pressure sensitive adhesive tape having a small thickness and exhibiting the above advantageous properties, it was found that the object could be achieved by a double coated pressure sensitive adhesive tape which was obtained by forming, on both faces of a core material, pressure sensitive adhesive layers comprising an acrylic ester-based copolymer having a weight-average molecular weight and a content of the butyl acrylate unit of prescribed values or greater and a tackifier in a specific amount as the main components and had a thickness of the entire tape of 30 μm or smaller and a thickness of the pressure sensitive adhesive layer at each face of the core material of 2 to 10 μm. The present invention has been completed based on the knowledge.

The present invention provides:

(1) A double coated pressure sensitive adhesive tape comprising a core material and pressure sensitive adhesive layers which comprise an acrylic ester-based copolymer having a weight-average molecular weight of 700,00 or greater and a content of a butyl acrylate unit of 90% by mass or greater and a tackifier as main components, have a content of the tackifier of 40 to 60% by mass and are disposed on both faces of the core material, wherein a thickness of the entire tape including the core material and the pressure sensitive adhesive layers disposed on both faces of the core material is 30 μm or smaller, and a thickness of the pressure sensitive adhesive layer on each face is 2 to 10 μm;
(2) The double coated pressure sensitive adhesive tape described in (1), wherein, when a thickness of the pressure sensitive adhesive layer on one face is represented by a (μm), and an adhesive strength of the pressure sensitive adhesive layer is represented by c (N/25 mm), the pressure sensitive adhesive layer on each face has a value of c/a in a range of 1.3 to 5.0;

### (3) The double coated pressure sensitive adhesive tape described in any one of (1) and (2), wherein a holding power of the pressure sensitive adhesive layers at both faces at 120° C. is 5 mm or smaller.

(4) The double coated pressure sensitive adhesive tape described in any one of (1) to (3), wherein a release film released under a greater force is attached to the pressure sensitive adhesive layer on one face of the core material and a release film released under a smaller force is attached to the pressure sensitive adhesive layer on the other face of the core material;

(5) The double coated pressure sensitive adhesive tape described in (4), wherein the release film released under a greater force has a thickness of 30 to 100 μm.

### THE EFFECT OF THE INVENTION

In accordance with the present invention, a double coated pressure sensitive adhesive tape which is transparent and thin, is advantageously used for fixing members of portable terminals such as portable telephones and PDA and thin film displays, laminating substrates in optical disks and fixing polarizing plates and exhibits excellent adhesive strength and holding power at high temperatures can be provided.

### THE MOST PREFERRED EMBODIMENT TO CARRY OUT THE INVENTION

The core material in the double coated pressure sensitive adhesive tape of the present invention is not particularly limited, and a core material is suitably selected from plastic films which are conventionally used as the core material of transparent double coated pressure sensitive adhesive tapes. Examples of the plastic film include films of polyesters such as polyethylene terephthalate, polybutylene terephthalate and polyethylene naphthalate, polyethylene films, polypropylene films, polyvinyl chloride films, polyvinylidene chloride films, polyvinyl alcohol films, ethylene-vinyl acetate copolymer films, polystyrene films, polycarbonate films, polymethylpentene films, polysulfone films, polyether ether ketone films, polyether sulfone films, polyphenylene sulfide films, polyether imide films, polyimide films, fluororesin films, polyamide films, acrylic resin films, norbornene-based resin films and cycloolefin resin films.

Among these films, polyethylene terephthalate films which are inexpensive and exhibit excellent transparency are mainly used. In applications requiring heat resistance, polyethylene naphthalate films having a high glass transition temperature (Tg) can be used.

For improving adhesion with the pressure sensitive adhesive layer formed on the face of the film, where desired, both faces may be subjected to a surface treatment such as an oxidation treatment and a roughening treatment or to a treatment with a primer. Examples of the oxidation treatment include the treatment with corona discharge, the treatment with plasma discharge, the treatment with chromic acid (a wet process), the treatment with flame, the treatment with the heated air and the treatment with ozone under irradiation with ultraviolet light. Examples of the roughening treatment include the sandblasting treatment and the treatment with a solvent. The surface treatment is suitably selected in accordance with the type of the plastic film. In general, the treatment with corona discharge is preferable from the standpoint of the effect and the operability.

In the double coated pressure sensitive adhesive tape of the present invention, the thickness of the core material is 26 μm or smaller based on the relation between the thickness of the entire tape and the thickness of the adhesive layer. The minimum value of the thickness is not particularly limited. In general, the minimum value of the thickness is about 2 μm.

In the present invention, the pressure sensitive adhesive layer formed on each face of the core material comprises an acrylic ester-based copolymer having a weight-average molecular weight of 700,000 or greater and a content of the butyl acrylate unit of 90% by weight or greater and a tackifier as the main components and has a content of the tackifier of 40 to 60% by mass.

When the content of the butyl acrylate unit is 90% by mass or greater in the acrylic ester-based copolymer, the excellent property for lamination and adhesive strength around the room temperature and at a high temperature (about 60° C.) can be obtained.

When the weight-average molecular weight of the acrylic ester-based copolymer is 700,000 or greater, cohesive failure does not take place easily even when the amount of the tackifier added for increasing the adhesive strength is in the range of 40 to 60% by mass. In other words, a great adhesive strength can be provided to a film even when the film has a small thickness since a great amount of the tackifier can be added. Moreover, the holding power at high temperatures is improved. The weight-average molecular weight is preferably 700,000 to 2,000,000 and more preferably 700,000 to 1,500,000.

The weight-average molecular weight is a value obtained in accordance with the gel permeation chromatography (GPC) and expressed as the value of the corresponding polystyrene.

As the pressure sensitive adhesive composition constituting the pressure sensitive adhesive layer in the double coated pressure sensitive adhesive tape of the present invention, a composition comprising the acrylic ester-based copolymer having a weight-average molecular weight of 700,000 or greater and the tackifier as the main components is used as described above.

Examples of the preferable acrylic ester-based copolymer described above include (a) butyl acrylate, (b) alkyl esters of (meth)acrylic acid other than butyl acrylate in which the alkyl group in the ester portion has 1 to 20 carbon atoms, (c) monomers having a crosslinking functional group in the molecule and (d) copolymers with other monomers which are used where desired.

Examples of the alkyl ester of (meth)acrylic acid other than butyl acrylate in which the alkyl group in the ester portion has 1 to 20 carbon atoms of component (b) include methyl(meth)acrylate, ethyl (meth)acrylate, propyl(meth)acrylate, butyl(meth)acrylate, pentyl (meth)acrylate, hexyl(meth)acrylate, cyclohexyl(meth)acrylate, 2-ethylhexyl(meth)acrylate, isooctyl(meth)acrylate, decyl(meth)acrylate, dodecyl(meth)acrylate, myristyl(meth)acrylate, palmityl(meth)acrylate and stearyl(meth)acrylate. The alkyl ester of (meth)acrylate may be used singly or in combination of two or more.

Examples of the monomer having a crosslinking functional group in the molecule of component (c) include hydroxyalkyl esters of (meth)acrylic acid such as 2-hydroxyethyl(meth)acrylate, 2-hydroxypropyl(meth)acrylate, 3-hydropropyl(meth)acrylate, 2-hydroxybutyl(meth)acrylate, 3-hydroxybutyl(meth)acrylate and 4-hydroxybutyl(meth)acrylate; monoalkylaminoalkyl esters of (meth)acrylic acid such as monomethyl-aminoethyl (meth)acrylate, monoethylaminoethyl(meth)acrylate, monomethylaminopropyl(meth)acrylate and monoethylaminopropyl (meth)acrylate; and ethylenically unsaturated carboxylic acids such as acrylic acid, methacrylic acid, crotonic acid, maleic acid, itaconic acid and citraconic acid. The above monomer may be used singly or in combination of two or more.

Examples of the other monomer of component (d) which is used where desired include vinyl esters such as vinyl acetate and vinyl propionate; olefins such as ethylene, propylene and isobutylene; halogenated olefins such as vinyl chloride and vinylidene chloride; styrene-based monomers such as styrene and α-methylstyrene; diene-based monomers such as butadiene, isoprene and chloroprene; nitrile-based monomers such as acrylonitrile and methacrylonitrile; and acrylamides such as acrylamide, N-methylacrylamide and N,N-dimethyl-acrylamide. The other monomer may be used singly or in combination of two or more.

The acrylic ester-based copolymer obtained by using butyl acrylate and the above monomers has a content of the butyl acrylate unit of 90% by mass or greater and a content of other monomer units of 10% by mass or smaller. The form of the copolymer is not particularly limited and may be any of a random copolymer, a block copolymer and a graft copolymer.

In the present invention, the acrylic ester-based copolymer may be used singly or in combination of two or more.

The pressure sensitive adhesive composition may comprise a crosslinking agent. The crosslinking agent is not particularly limited, and a suitable crosslinking agent can be selected from crosslinking agents conventionally used for acrylic resins. Examples of the crosslinking agent include polyisocyanate compounds, epoxy resins, melamine resins, urea resins, dialdehyde resins, methylol polymers, aziridine-based compounds, metal chelate compounds, metal alkoxides and metal salts. Among these compounds, polyisocyanate compounds are preferable.

Examples of the polyisocyanate compound include aromatic polyisocyanates such as tolylene diisocyanate, diphenylmethane diisocyanate and xylylene diisocyanate; aliphatic polyisocyanates such as hexamethylene diisocyanate; alicyclic polyisocyanates such as isophorone diisocyanate and hydrogenated diphenylmethane diisocyanate; biuret compounds and isocyanurate compounds of the above polyisocyanates; and adduct compounds which are reaction products with low molecular compounds having active hydrogen atom such as ethylene glycol, propylene glycol, neopentyl glycol, trimethylolpropane and castor oil.

In the present invention, the crosslinking agent may be used singly or in combination of two or more. The amount is selected, in general, in the range of 0.01 to 20 parts by mass and preferably in the range of 0.1 to 10 parts by mass per 100 parts by mass of the acrylic ester-based copolymer although the amount is different depending on the type of the crosslinking agent.

In the pressure sensitive adhesive composition, the tackifier which constitutes the main component in combination with the acrylic ester-based copolymer is not particularly limited, and a suitable tackifier can be selected from tackifiers conventionally used for pressure sensitive adhesives. Examples of the tackifier include rosin-based resins such as raw rosin, hydrogenated rosin and rosin ester-based resins, xylene resins, terpene-phenol resins, petroleum resins, coumarone-indene resins, terpene resins, styrene resins, ethylene/vinyl acetate resins and elastomers such as styrene-butadiene block polymers, styrene-isoprene block polymers, ethylene-isoprene-styrene block polymers, vinyl chloride/vinyl acetate-based polymers and acrylic rubbers.

Examples of the commercial products include rosin esters such as PINE CRYSTAL KE-359 [manufactured by ARAKAWA KAGAKU KOGYO Co., Ltd.], SUPER ESTER A-75 [manufactured by ARAKAWA KAGAKU KOGYO Co., Ltd.], SUPER ESTER A-100 [manufactured by ARAKAWA KAGAKU KOGYO Co., Ltd.] and SUPER ESTER A-125 [manufactured by ARAKAWA KAGAKU KOGYO Co., Ltd.]; polymerized rosin esters such as PENCEL D125 [manufactured by ARAKAWA KAGAKU KOGYO Co., Ltd.], PENCEL D160 [manufactured by ARAKAWA KAGAKU KOGYO Co., Ltd.] and RIKATACK PCJ [manufactured by RIKA FINETECH Co., Ltd.]; xylene resins such as NIKANOL HP-100 [manufactured by MITSUBISHI GAS KAGAKU Co., Ltd.], NIKANOL HP-150 [manufactured by MITSUBISHI GAS KAGAKU Co., Ltd.] and NIKANOL H-80 [manufactured by MITSUBISHI GAS KAGAKU Co., Ltd.]; terpene-phenol resins such as YS POLYSTAR Y-115 [YASUHARA CHEMICAL Co., Ltd.] and MYTECK G125 [YASUHARA CHEMICAL Co., Ltd.]; and petroleum resins such as FTR-6120 [manufactured by MITSUI KAGAKU Co., Ltd.] and FTR-6100 [manufactured by MITSUI KAGAKU Co., Ltd.]

The tackifier may be used singly or in combination of two or more. Among the above tackifiers, rosin ester-based tackifiers are preferable from the standpoint of the effect of providing tackiness.

In the present invention, it is necessary that the pressure sensitive adhesive layer comprises the tackifier in an amount of 40 to 60% by mass (as the content of the solid components). The desired tackiness can be obtained when the amount of the tackifier is within the above range. It is preferable that the content of the tackifier is in the range of 50 to 60% by mass.

Various additives such as antioxidants, ultraviolet light absorbents, light stabilizers, coupling agents, fillers and coloring agents may be added to the pressure sensitive adhesive composition, where desired, as long as the object of the present invention is not adversely affected.

The process for forming the pressure sensitive adhesive layer on both faces of the core material using the above pressure sensitive adhesive composition will be described later.

The double coated pressure sensitive adhesive tape of the present invention has a thickness of the entire tape of 30 μm or smaller. When the thickness of the entire tape exceeds 30 μm, the object of the present invention, i.e., to provide a double coated pressure sensitive tape having a small thickness, is not achieved. The minimum thickness of the entire tape is about 6 μm.

The thickness of the pressure sensitive adhesive layer at each face of the core material is 2 to 10 μm. When the thickness is smaller than 2 mm, problems such as deterioration in the property for lamination and a decrease in the adhesive strength arise. When the thickness exceeds 10 μm, the thickness of the core material relatively decreases, and a decrease in the property for working arises.

The two pressure sensitive adhesive layers disposed on both faces of the core material may have the same thickness or thicknesses different from each other as long as the thicknesses are within the above range.

The method for measuring the thickness of the pressure sensitive adhesive layer will be described later.

When the thickness of a pressure sensitive adhesive layer on one face is represented by a (mm), and the adhesive strength of the pressure sensitive adhesive layer is represented by c (N/25 mm), it is preferable that the value of c/a of the pressure sensitive adhesive layer on each face is in the range of 1.3 to 5.0. When the value of c/a is 1.3 or greater, the adhesive strength is sufficiently exhibited, and durability is excellent. When the value of c/a is 5.0 or smaller, peeling off can be achieved without causing damages on the core material when the lamination is not performed correctly, and the condition is preferable for working. It is more preferable that the value of c/a is in the range of 1.5 to 2.9.

The adhesive strength is, in general, about 1 to 25 N/25 mm and preferably 5 to 15 N/25 mm. The adhesive strength is the value obtained in accordance with the method of Japanese Industrial Standard Z 1528: 2004.

In the double coated pressure sensitive adhesive tape of the present invention, the holding power can be made 5 mm or smaller at 120° C. When the holding power is in the above range, the double coated pressure sensitive adhesive tape exhibits durability at high temperatures such as the temperature in a vehicle in the summer time. The method for measuring the holding power at 120° C. will be described later.

In the double coated pressure sensitive adhesive tape of the present invention, in general, a release film released under a greater force is attached to the pressure sensitive adhesive layer on one face of the core material and a release film released under a smaller force is attached to the pressure sensitive adhesive layer on the other face of the core material. The release film released under a greater force has a peeling strength greater than that of the release film released under a smaller force. The peeling strength of the release film released under a greater force with respect to the pressure sensitive adhesive layer in the present invention is, in general, about 100 to 400 mN/50 mm and preferably about 150 to 300 mN/50 mm. The peeling strength of the release film released under a smaller force with respect to the pressure sensitive adhesive layer in the present invention is, in general, about 30 to 150 mN/50 mm and preferably about 50 to 100 mN/50 mm.

The method for measuring the peeling strength of each release film described above will be described later.

In the present invention, adhesive strength, holding power, thickness of a pressure sensitive adhesive layer and peeling strength of a release film are defined as those measured by the methods shown in (1), (2), (3) and (4), respectively, in the preceding section in EXAMPLES of the specification.

In the present invention, it is preferable that the thickness of the release film released under a greater force is 30 to 100 μm. When the thickness is 30 μm or greater, the property for working in the die-cutting is excellent. When the thickness of 100 μm or smaller, the firmness is suitable. Moreover, the property for working is excellent, and economic advantage can be obtained.

The thickness of the release film released under a smaller force is not particularly limited. From the standpoint of the property for working and economy, a thickness of about 25 to 50 μm is preferable.

The materials for the release film released under a greater force and the release film released under a smaller force are not particularly limited. Examples of the materials include polyolefin films such as polyethylene films and polypropylene films and polyester films such as polyethylene terephthalate films. Among these materials, polyethylene terephthalate films which are inexpensive, have firmness and exhibit excellent transparency are preferable. As the releasing agent coating the surface of the film, releasing agents such as silicone-based agents, fluorine-based agents and long chain alkyl-based agents can be used. Among these agents, silicone-based agents which are inexpensive and provide the necessary properties with stability are preferable. In applications where silicone-based agents exhibit adverse effects, long alkyl-based releasing agents can be used.

The process for producing the double coated pressure sensitive adhesive tape of the present invention will be described in the following.

As the first step, the viscosity of the adhesive composition described above is adjusted to a value suitable for the coating by adding a solvent to the composition, where necessary, and a coating fluid is prepared.

Then, the face for the releasing treatment of a release film released under a greater force (or the release film released under a smaller force) is coated with the coating fluid prepared above in accordance with a conventional coating process such as the bar coating process, the reverse roll coating process, the knife coating process, the roll knife coating process, the gravure coating process, the air doctor coating process and the doctor blade coating process in an amount such that the formed layer has a thickness of 2 to 10 μm after being dried, and the formed coating layer is dried at a temperature of about 80 to 120° C. for several tens seconds to several minutes. A core material is laminated to the formed adhesive layer, and a film having the pressure sensitive adhesive layer on one face is prepared.

Then, in accordance with the same procedures as those conducted above, the face for the release film released under a smaller force (or the release film released under a greater force) is coated with the coating fluid prepared above in an amount such that the formed layer has a thickness of 2 to 10 μm after being dried, and the formed coating layer is dried. The face of the plastic film in the film having the pressure sensitive adhesive layer on one face prepared above is laminated to the formed adhesive layer, and the double coated pressure sensitive adhesive tape of the present invention can be obtained.

When the core material has a thickness of about 6 μm or greater, the coating fluid may be directly applied to the core material and dried, and the release sheet may be laminated to the formed coating layer.

The double coated pressure sensitive adhesive tape of the present invention prepared in the manner described above is a transparent and thin film and exhibits excellent adhesive strength and holding power at high temperatures.

### EXAMPLES

The present invention will be described more specifically with reference to examples in the following. However, the present invention is not limited to the examples.

The properties of double coated pressure sensitive adhesive tapes obtained in Examples and Comparative Examples were obtained in accordance with the following methods.

### (1) Adhesive Strength

The adhesive strength was measured in accordance with the method of Japanese Industrial Standard Z 1528: 2004 using a test piece having a width of 25 mm.

One of the adhesive faces of the test piece was attached to a test plate (a stainless steel plate), and the release film on the other face is removed. A polyethylene terephthalate film specified in Japanese Industrial Standard C 2318 and having approximately the same size as that of the test piece (the nominal thickness: No. 25) was attached to the exposed face, and the formed laminate was pressed. The adhesive strength to the test place (the stainless steel plate) under 180° peeling was obtained in accordance with the method of Japanese Industrial Standard Z 0237 10 (the adhesive strength).

### (2) Holding Power

The holding power was measured in accordance with the method of Japanese Industrial Standard Z 1528: 2004 using a test piece having a width of 25 mm except that temperature of the measurement is changed to 120° C. from 40° C. of the Standard.

A portion having a length of 25 mm of one of the adhesive faces of the test piece was attached to a metal plate made of stainless steel, and the release film on the other face was removed. A polyethylene terephthalate film specified in Japanese Industrial Standard C 2318 and having approximately the same size as that of the test piece (the nominal thickness: No. 25) was attached to the exposed face, and the formed laminate was pressed and then left standing at 120° C. for 1 hour. The resultant laminate was held at 120° C. for 1 hour under a load of 9.807 N (1,000 g), and the amount of slippage was used as the holding power.

### (3) Thickness of a Pressure Sensitive Adhesive Layer

The thickness was measured using a thickness meter manufactured by TECLOCK Company “PG02” (the diameter of the measuring tool: 5 mm) under a constant pressure.

To accurately measure the thickness of an adhesive layer, 10 double coated tapes (release film A/adhesive layer A/a core material/adhesive layer B/release film B) were laid one on top of another, and the thickness of the resultant laminate having 10 tapes was measured. The thickness of the tape s was obtained by dividing the obtained value by 10.

Release film A was removed, and adhesive layer A was removed with a solvent not dissolving the core material. Ten films thus obtained each having a structure of the core material/adhesive layer B/release film B were laid one on top of another, and the thickness of the resultant laminate was measured. The thickness of the film t was obtained by dividing the obtained value by 10.

The thickness u of release film A was obtained in a similar manner, and the thickness of adhesive layer A was obtained by subtracting the thicknesses t and u from the thickness of the tape s. (The thickness was measured in accordance with this method in Examples 1 to 3 and Comparative Examples 1 and 2.)

As another method of the measurement, two films having a known thickness were laminated with a double coated pressure sensitive adhesive tape, and a picture of the section of the obtained laminate was taken by an electron microscope. The thickness of the adhesive layer could be obtained by comparing the thickness of the films having the known thickness and the thickness of the adhesive layer.

### (4) Peeling Strength of a Release Film

The release film at the side opposite to the face for the measurement was removed in a test piece having a width of 50 mm. The exposed adhesive layer was attached to a glass plate, and the release film on the face for the measurement was peeled in the direction of 180° at a speed of 300 mm/min. The resistance to the peeling was measured and used as the peeling strength.

### Preparation Example 1

### Preparation of Adhesive Composition 1 (Coating Fluid 1)

To 100 parts by mass of an ethyl acetate solution of an acrylic ester-based copolymer having a weight-average molecular weight of 800,000 (the butyl acrylate unit: 95% by mass; the acrylic acid unit: 2% by mass; the methyl methacrylate unit: 3% by mass) in a concentration of 30% by mass, 30 parts by mass of a tackifier [manufactured by ARAKAWA KAGAKU KOGYO Co., Ltd.; the trade name: “PINE CRYSTAL KE-359”; a rosin ester-based tackifier; the softening point: 94˜104° C.; the acid value: 10˜20 mg KOH/g] and 1 part by mass of an isocyanate-based crosslinking agent [manufactured by TOYO INK SEIZO Co., Ltd.; the trade name: “BHS8515”; the concentration of solid components: 37.5% by mass] were added. The resultant mixture was diluted with toluene, and Adhesive composition 1 (Coating composition 1) having a concentration of solid components of 20% by mass was prepared.

### Preparation Example 2

### Preparation of Adhesive Composition 2 (Coating Fluid 2)

Adhesive composition 2 (Coating composition 2) was prepared in accordance with the same procedures as those conducted in Preparation Example 1 except that an acrylic ester-based copolymer having a weight-average molecular weight of 500,000 was used.

### Preparation Example 3

### Preparation of Adhesive Composition 3 (Coating Fluid 3)

Adhesive composition 3 (Coating composition 3) was prepared in accordance with the same procedures as those conducted in Preparation Example 1 except that 10 parts by weight of the tackifier was used.

### Example 1

The face for treatment of a polyethylene terephthalate (PET) release film released under a smaller force [manufactured by LINTEC Corporation; the trade name: “SP-PET 38GS”; the thickness of the film: 38 μm] was coated with Coating fluid 1 obtained in Preparation Example 1 using a knife coater in an amount such that the formed film had a thickness of 4 μm after being dried. After being dried at 100° C. for 1 minute, the obtained coated film was laminated to a PET film of the core material [manufactured by TORAY Co., Ltd.; the trade name: “PET6 CF-53”; thickness of the film: 6 μm], and Single coated pressure sensitive adhesive film 1 was obtained.

The face for treatment of a PET release film released under a greater force [manufactured by LINTEC Corporation; the trade name: “SP-PET 50C”; the thickness of the film: 50 μm] was coated with Coating fluid 1 obtained in Preparation Example 1 using a knife coater in an amount such that the formed film had a thickness of 4 μm after being dried. After being dried at 100° C. for 1 minute, the obtained coated film was laminated to the face of PET in Single coated pressure sensitive adhesive film 1 prepared above, and a double coated pressure sensitive adhesive tape was prepared.

In the obtained double coated pressure sensitive adhesive tape, the PET release film released under a smaller force had a peeling strength of 90 mN/50 mm, and the PET release film released under a greater force had a peeling strength of 170 mN/50 mm.

The properties of the double coated pressure sensitive adhesive tape are shown in Table 1.

### Example 2

A double coated pressure sensitive adhesive tape was prepared in accordance with the same procedures as those conducted in Example 1 except that a PET film manufactured by MITSUBISHI KAGAKU POLYESTER FILM Co., Ltd. [the trade name: “PET2 C660”, the thickness of the film: 2 μm] was used as the PET film of the core material.

The properties of the double coated pressure sensitive adhesive tape are shown in Table 1.

### Example 3

A double coated pressure sensitive adhesive tape was prepared in accordance with the same procedures as those conducted in Example 1 except that the face for the releasing treatment of the PET release film released under a smaller force and the face for the releasing treatment of the PET release film released under a greater force were each coated with Coating fluid 1 in an amount such that the formed film had a thickness of 7 μm after being dried.

The properties of the double coated pressure sensitive adhesive tape are shown in Table 1.

### Comparative Example 1

A double coated pressure sensitive adhesive tape was prepared in accordance with the same procedures as those conducted in Example 1 except that Coating fluid 2 obtained in Preparation Example 2 was used.

The properties of the double coated pressure sensitive adhesive tape are shown in Table 1.

### Comparative Example 2

A double coated pressure sensitive adhesive tape was prepared in accordance with the same procedures as those conducted in Example 1 except that Coating fluid 3 obtained in Preparation Example 3 was used.

The properties of the double coated pressure sensitive adhesive tape are shown in Table 1.

TABLE 1

| | | | | Comparative | |
|---|---|---|---|---|---|
| | Example | | | Example | |
| | 1 | 2 | 3 | 1 | 2 |
| Weight-average molecular | 800 | 800 | 800 | 500 | 800 |
| weight of acrylic ester-based | | | | | |
| copolymer, ×1000 | | | | | |
| Content of tackifier (% by mass) | 49.7 | 49.7 | 49.7 | 49.7 | 24.8 |
| Adhesive strength [c] | 8.8 | 8.9 | 12.4 | 10.1 | 24.8 |
| (N/25 mm) | | | | | |
| Holding power at 120° C. (mm) | 0 | 0 | 0 | dropped | 2 |
| Thickness of adhesive layer [a] | 4.0 | 4.0 | 7.0 | 4.0 | 4.0 |
| (μm) | | | | | |
| Thickness of entire tape (μm) | 14 | 10 | 20 | 14 | 14 |
| c/a value | 2.2 | 2.2 | 1.8 | 2.5 | 1.1 |

### The thickness of the adhesive layer [a] is the same for the adhesive layers at both faces of the core material.

### INDUSTRIAL APPLICABILITY

The double coated pressure sensitive adhesive tape of the present invention is transparent and thin, has excellent adhesive strength and holding power, exhibits excellent properties for working and is advantageously used for fixing members of portable terminals such as portable telephones and PDA and thin film displays, laminating substrates in optical disks and fixing polarizing plates

What is claimed is:

1. A double coated pressure sensitive adhesive tape comprising a core material and pressure sensitive adhesive layers which comprise an acrylic ester-based copolymer having a weight-average molecular weight of 700,00 or greater and a content of a butyl acrylate unit of 90% by mass or greater and a tackifier as main components, have a content of the tackifier of 40 to 60% by mass and are disposed on both faces of the core material, wherein a thickness of the entire tape including the core material and the pressure sensitive adhesive layers disposed on both faces of the core material is 30 μm or smaller, and a thickness of the pressure sensitive adhesive layer on each face is 2 to 10 μm.

2. The double coated pressure sensitive adhesive tape according to claim 1, wherein, when a thickness of the pressure sensitive adhesive layer on one face is represented by a (μm), and an adhesive strength of the pressure sensitive adhesive layer is represented by c (N/25 mm), the pressure sensitive adhesive layer on each face has a value of c/a in a range of 1.3 to 5.0.

3. The double coated pressure sensitive adhesive tape according to claim 1, wherein a holding power of the pressure sensitive adhesive layers at both faces at 120° C. is 5 mm or smaller.

4. The double coated pressure sensitive adhesive tape according to claim 2, wherein a holding power of the pressure sensitive adhesive layers at both faces at 120° C. is 5 mm or smaller.

5. The double coated pressure sensitive adhesive tape according to claim 1, wherein a release film released under a greater force is attached to the pressure sensitive adhesive layer on one face of the core material and a release film released under a smaller force is attached to the pressure sensitive adhesive layer on the other face of the core material.

6. The double coated pressure sensitive adhesive tape according to claim 2, wherein a release film released under a greater force is attached to the pressure sensitive adhesive layer on one face of the core material and a release film released under a smaller force is attached to the pressure sensitive adhesive layer on the other face of the core material.

7. The double coated pressure sensitive adhesive tape according to claim 3, wherein a release film released under a greater force is attached to the pressure sensitive adhesive layer on one face of the core material and a release film released under a smaller force is attached to the pressure sensitive adhesive layer on the other face of the core material.

8. The double coated pressure sensitive adhesive tape according to claim 4, wherein a release film released under a greater force is attached to the pressure sensitive adhesive layer on one face of the core material and a release film released under a smaller force is attached to the pressure sensitive adhesive layer on the other face of the core material.

9. The double coated pressure sensitive adhesive tape according to claim 5, wherein the release film released under a greater force has a thickness of 30 to 100 μm.

10. The double coated pressure sensitive adhesive tape according to claim 6, wherein the release film released under a greater force has a thickness of 30 to 100 μm.

11. The double coated pressure sensitive adhesive tape according to claim 7, wherein the release film released under a greater force has a thickness of 30 to 100 μm.

12. The double coated pressure sensitive adhesive tape according to claim 8, wherein the release film released under a greater force has a thickness of 30 to 100 μm.
